(19) United States
(12) Patent Application Publication
(10) Pub. No.: US 2023/0214520 A1
(43) Pub. Date: Jul. 6, 2023

(54) SYSTEMS, METHODS AND COMPUTER PROGRAM PRODUCTS FOR MESSAGING IN A HETEROGENEOUS ENVIRONMENT

(71) Applicant: Real Innovations International LLC, Georgetown (CA)

(72) Inventor: Andrew S. Thomas, Gerogetown (CA)

(21) Appl. No.: 18/067,369

(22) Filed: Dec. 16, 2022

Related U.S. Application Data
(60) Provisional application No. 63/295,288, filed on Dec. 30, 2021.

(51) Int. Cl. G06F 21/62

(52) U.S. Cl. CPC G06F 21/6236

(57) ABSTRACT

Methods, systems, and computer program products are provided for messaging in a heterogeneous environment. A first connection is established between a first messaging device that can store a first schema and a second messaging device that can store at least one processing rule and at least one schema including the first schema. The first messaging device sends to the second messaging device, via the first connection, a first message structured according to the first schema. The second messaging device receives the first message. The second messaging device identifies that the first message is structured according to the first schema. In turn, the second messaging device processes the first message using the processing rule.

### CROSS REFERENCE TO RELATED APPLICATIONS

This application claims priority to, and the benefit of, U.S. Provisional Patent Application Ser. No. 63/295,288, filed Dec. 30, 2021, which is hereby incorporated by reference in its entirety.

### BACKGROUND

### I. Field

The present invention generally relates to data communications, and more particularly to systems and methods for sending and receiving messages in heterogeneous environments.

### II. Related Art

The Internet of Things (IoT) is composed of a large and heterogeneous set of devices, software systems, and networks. A myriad of protocols and standards have been used to address the requirements of this new technological approach. The number of protocols and standards continues to grow as the number of new applications increase. Consequently, one of the major challenges today is the interoperability between systems with heterogeneous characteristics. A data communications message between IoT devices can be thought of as two distinct parts: an envelope (sometimes referred to as a message envelope) and a payload (sometimes referred to as a message payload) contained within that envelope. The envelope contains information about the delivery and disposition of the message. For example, the envelope may contain data about the length of the payload, how the payload should be routed, whether the message should be persisted and retried in the event of a failure, and so on. The payload is comprised of data (e.g., such as an ordered series of characters used to convey information, a memory access request, an acknowledgement, etc.) that is to be transferred from a source node to a destination node; and the data is generally organized in a preestablished layout known as a format. Many IoT or other types of data communication systems are heterogenous systems, where products with different envelopes and payload formats are expected to interoperate within the same system.

The Message Queue Telemetry Transport (MQTT) protocol is an inter-process communication protocol designed to allow IoT applications to communicate with one another via a publish/subscribe communication model. By design, MQTT does not place any expectations on the syntax or semantics of the payload. This makes it very flexible in the sense that any message can be delivered. A typical MQTT system consists of a single “broker” application that acts as a server, and one or more “client” applications that send and receive messages to and from the broker. The broker's purpose is to act as a central point of contact for all clients in the system, and to route messages written by clients to other clients that have subscribed to them. In MQTT, messages can be distinguished by the utilization of so-called “topics”. MQTT topics are a form of addressing that allows MQTT clients to share information. A topic can be, for example, a unique name in the form of a string. Clients write messages to a topic to publish data into the system, and other clients subscribe to those topics to express an interest in receiving those messages. Client applications do not communicate directly with one another, instead either publishing or subscribing to topics retained by a broker application.

One significant technical problem with MQTT is that it poses an interoperability challenge. Since there is no payload specification, two clients operating in accordance with MQTT publishing and subscribing using the same MQTT topic may still not be communicating effectively because they may not agree on the syntax or semantics of the payload. For an MQTT system to operate, client applications must implicitly agree on both the syntax and semantics of all payloads on all topics for which they intend to share data.

In a heterogenous system, products from more than one developer are expected to interoperate within the same system. Each developer of a product can define their product's own payload format, and then document the format so that other developers can program their applications to expect and process messages from the product in that format. Therefore application developers who intend their product to be interoperable with other developers' applications will need to program their applications to interpret messages from all publishers. This quickly becomes a technical problem of O(N²) complexity, where N is the number of distinct publisher applications in the system—or worse, the number of distinct publisher applications that could be in the system. This is approach is deemed sufficiently impractical that it generally is not attempted.

Most MQTT publisher applications encode their message payloads in JSON (JavaScript Object Notation) format. This is a structured text format with sufficient expressiveness to encode most information an application would need to publish. A JSON payload is simple to generate and to parse, but it does not resolve the problem of interoperability. One attempt to solve this problem has been a protocol called Sparkplug B, which defines a specific set of MQTT topics and a payload specification that all compliant applications must support. However, Sparkplug B has limited industry adoption, is complex to implement, and suffers from deficiencies that make it impractical in non-simplistic systems. Sparkplug B attempts to solve the problem of interoperability by stipulating the format of a certain message and the corresponding MQTT topic. Sparkplug B further requires all applications to adhere to those stipulations. In other words, applications operating under the Sparkplug B protocol require other applications to be engineered specifically under the same protocol in order to interoperate.

### SUMMARY

The foregoing interoperability problem and other limitations are overcome by systems, methods, and non-transitory computer medium storing instructions, for sending and receiving messages in heterogeneous environments in terms of various formats, syntax, protocols, etc., between devices, applications, threads, or other entities.

In one embodiment, a method is provided for messaging in a heterogeneous environment. The method includes establishing a first connection between a first messaging device and a second messaging device, the first messaging device having a first memory configured to store a first schema and the second messaging device having a second memory configured to store at least one processing rule and at least one schema including the first schema. Furthermore, the method includes sending, by the first messaging device to the second messaging device via the first connection, a first message, the first message being structured according to the first schema stored in the first memory; and receiving, by the second messaging device, the first message. Furthermore, the method includes identifying, by the second messaging device, that the first message is structured according to the first schema stored in the second memory; and in turn, processing, by the second messaging device, the first message using the processing rule, wherein the processing generates processed data; and storing the processed data in the second memory.

In some embodiments, the method includes configuring the first messaging device to be a broker device storing a topic mapping repository and a plurality of schemas in the first memory, wherein the topic mapping repository maps the plurality of schemas to correspond to a plurality of topics including a target topic; selecting, from the plurality of schemas stored in the first memory, a target schema based on the target topic and the topic mapping repository, the target schema corresponding to the target topic; and composing a target message structured according to the target schema, wherein the first message sent by the first messaging device to the second messaging device via the first connection is the target message.

In some embodiments, the second messaging device can be a subscriber device, the subscriber device being configured to send a subscription request, via the first connection, to the broker device indicating the target topic.

The first messaging device, in some embodiments, is a publisher device, the publisher device being configured to construct a published message including a published topic, the published message being the first message sent by the first messaging device to the second messaging device via the first connection. The method can further include configuring the second messaging device to be a broker device storing a topic mapping repository and a plurality of schemas in the second memory, wherein the topic mapping repository maps the plurality of schemas to correspond to a plurality of topics including a target topic; selecting, from the plurality of schemas stored in the second memory, a target schema based on the target topic and the topic mapping repository, the target schema corresponding to the target topic; and composing, from the processed data, a target message structured according to the target schema.

In an example implementation, the method further comprises establishing a second connection between the broker device and a third messaging devices, the third messaging device being configured to be a subscriber device; and sending, by the broker device, the target message to the subscriber device. In yet another example implementation, the method further comprises storing, in the broker device, a control protocol defining at least one control rule for a control engine to control at least one actuator according to a control message; composing, from the processed data, the control message structured according to the control protocol; and sending, by the broker device, the control message to the subscriber device, wherein the subscriber device includes the control engine being configured to control the actuator according to the control message based on the control protocol.

In still further embodiments, the method comprises establishing a second connection between the broker device and a data storage system, the data storage system being configured to store the processed data; and sending, by the broker device, the target message to the data storage system. In some embodiments, the method further comprises establishing a second connection between the broker device and a data analysis system, the data analysis system being configured to analyze the processed data; and sending, by the broker device, the target message to the data analysis system.

The method can further include generating updated data, by the broker device, from the processed data; composing, from the updated data, an update message structured according to the first schema, the update message being associated with the published topic; and sending, by the broker device, the update message to the publisher device via the first connection.

In an example implementation, the first message is structured according to a Message Queue Telemetry Transport (MQTT) protocol.

In another embodiment, there is provided a system including at least one computing device, at least one memory, and a first application and a second application executable by the at least one computing device. The first application is configured to send a first message to the second application. The first message is structured according to a first schema stored in the memory. The second application is configured to receive the first message from the first application. The second application identifies that the first message is structured according to the first schema stored in the memory. The second application processes the first message using a processing rule stored in the memory, the processing generates processed data. In turn, the second application stores the processed data in the memory.

The first application can be is executable by a first computing device having a first memory and the second application can be executable by a second computing device having a second memory. The first computing device and the second computing device are being configured to communicate via a first connection. The first computing device, executing the first application, is configured to receive a subscription request from the second computing device. The second computing device is configured to be a subscriber device. The first computing device stores a topic mapping repository and a plurality of schemas in the first memory. The topic mapping repository maps the plurality of schemas to correspond to a plurality of topics including a target topic. The first computing device selects, from the plurality of schemas stored in the first memory, a target schema based on the target topic and the topic mapping repository. The target schema corresponds to the target topic. In turn, the first computing device composes a target message structured according to the target schema. The first message sent by the first application to the second application is the target message.

In other implementations, the first computing device, executing the first application, is configured to construct the first message to be a published message including a published topic. The second computing device, executing the second application, is configured to store a topic mapping repository and a plurality of schemas in the second memory. The topic mapping repository maps the plurality of schemas to correspond to a plurality of topics including a target topic. The second computing device selects, from the plurality of schemas stored in the second memory, a target schema based on the target topic and the topic mapping repository. The target schema corresponds to the target topic. In turn, the second computing device composes, from the processed data, a target message structured according to the target schema.

A third application executable by a third computing device is configured to be in communication with the second computing device via a second connection. The second computing device, executing the second application, is further configured to send the target message to the third computing device via the second connection.

It is also provided that the second computing device, executing the second application, can be further configured to generate updated data from the processed data. The second computing device composes, from the updated data, an update message structured according to the first schema. In turn, the second computing device sends the update message to the first computing device via the first connection.

Sometimes the first application is executable as a first thread of a programming job and the second application is executable as a second thread of the programming job. The programming job is being configured to be executed by the at least one computing device.

In yet another embodiment, there is provided a non-transitory computer-readable medium having stored thereon one or more sequences of instructions, which when executed by one or more processors, cause the one or more processors to perform the methods herein. For example, the non-transitory computer-readable medium, in some embodiments, has stored thereon one or more sequences of instructions, which when executed by one or more processors, cause the one or more processors to load at least one processing rule and at least one schema from a memory. The one or more processors are caused to receive a first message and identify that the first message is structured according to the schema, and process the first message using the processing rule, wherein the processing generates processed data. In turn, the processed data is stored by one or more processors to the memory.

In some embodiments, the one or more processors are further caused to load a topic mapping repository and a plurality of schemas from the memory. The topic mapping repository maps the plurality of schemas to correspond to a plurality of topics. The one or more processors are caused to load a target topic from the memory, the target topic being associated with the processed data, and to select, from the plurality of schemas, a target schema based on the target topic and the topic mapping repository. The target schema corresponds to the target topic. In turn, the one or more processors are caused to compose, from the processed data, a target message structured according to the target schema.

In some implementations, the methods, systems, and instructions stored in non-transitory computer-readable medium are provided according to a Message Queue Telemetry Transport (MQTT) protocol.

### BRIEF DESCRIPTION OF THE DRAWINGS

The features and advantages of the example embodiments presented herein will become more apparent from the detailed description set forth below when taken in conjunction with the following drawings.

FIG. 1 is a system diagram illustrating an example system for data communication in a heterogeneous environment, in accordance with an embodiment.

FIG. 2 is system flow diagram illustrating an example system and processes for sending and receiving messages in a heterogeneous environment, in accordance with an embodiment.

FIG. 3 is a flow chart illustrating an example method for sending and receiving messages in a heterogeneous environment, in accordance with an embodiment.

FIG. 4 is a system flow diagram illustrating an example broker-subscriber system and processes for sending and receiving messages in a heterogeneous environment, in accordance with an embodiment.

FIG. 5 is a flow chart illustrating an example broker-subscriber method for sending and receiving messages in a heterogeneous environment, in accordance with an embodiment.

FIG. 6A is a system flow diagram illustrating an example publisher-broker system and processes for sending and receiving messages in a heterogeneous environment, in accordance with an embodiment.

FIG. 6B is a system flow diagram illustrating another example publisher-broker system and processes for sending and receiving messages in a heterogeneous environment, in accordance with an embodiment.

FIG. 7 is a flow chart illustrating an example publisher-broker method for sending and receiving messages in a heterogeneous environment, in accordance with an embodiment.

FIG. 8 is a system flow diagram illustrating an example close-loop publisher-broker system and processes for sending and receiving messages in a heterogeneous environment, in accordance with an embodiment.

FIG. 9 is a flow chart illustrating an example close-loop publisher-broker method for sending and receiving messages in a heterogeneous environment, in accordance with an embodiment.

FIG. 10 illustrates an example computing system on which aspects of the present disclosure may be implemented.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware only implementation, a software only implementation, or an implementation combining software and hardware aspects. The following detailed description is therefore not to be taken in a limiting sense, and the scope of the present disclosure is defined by the appended claims and their equivalents.

Generally, example aspects of the embodiments described herein provide systems, methods, and non-transitory computer medium storing instructions for sending and receiving messages in heterogeneous environments in various formats, syntaxes, protocols, etc., between devices, applications, threads, or other entities. Example aspects of the embodiments described herein solve the problem of interoperability by adapting to the formats of messages generated by the source applications. For example, the solution maintains a set of processing rules for each of the expected formats of messages, identifies the correct processing rules by examining incoming messages, and then processes those messages according to identified processing rules. Modifications to existing MQTT applications are not required.

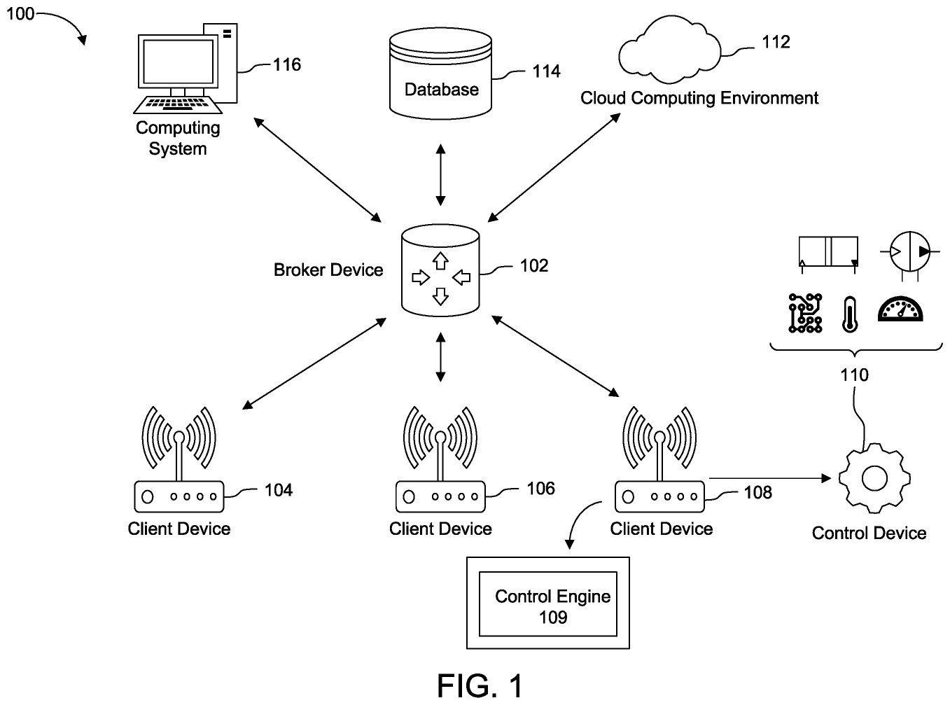

FIG. 1 illustrates an example heterogeneous system 100 and processes for providing data communication in a heterogeneous environment. In some embodiments, the heterogeneous system 100 includes a broker device 102, a cloud computing environment 112, a database 114, a computing system 116, and plural client devices, such as client device 104, client device 106, and client device 108. Client device 104, client device 106, and client device 108 are also referred to herein as first client device 104, second client device 106, and third client device 108, respectively.

In some embodiments, broker device 102 is in the form of an architecture that collects data from multiple sources, organizes the data for distribution, subsetting and/or sharing. In some embodiments, broker device 102 may be in the form of a special purpose device or downloadable computer software for connecting, aggregating, modifying, integrating, redistributing, and visualizing live information between publishers and users in real time for industrial monitoring, automation, and process control. In some embodiments, broker device 102 may be one or more devices executing software that enables real-time, bidirectional connections to Open Platform Communication (OPC) Unified Architecture (UA) clients, Data Access (DA) clients, and Alarms and Events (A&E) clients and servers. Broker device 102 may also connect any Structured Query Language (SQL) database, Modbus agent (or slave), Excel spreadsheet, custom programs, embedded systems, Microsoft® Azure IoT Hub, Google IoT, Amazon IoT Core, any standard MQTT client or broker, and popular real-time data historians.

In the example heterogenous system 100, client devices in communication are expected to interoperate, meaning they are expected to connect and communicate with one another readily, even though each developer of a device can define the message format for that device independently. For instance, messages sent and received between the broker device 102 and client device 104 can be in a format different from the format between the broker device 102 and client device 106. Where, for example, client device 106 requires information from messages sent from client device 104, broker device 102 is configured to receive the messages sent from the client device 104, recognize the format to which the messages sent from the client device 104 are structured, reformat the client device 104 messages into a format that client device 106 is configured to adopt, and, in turn, route the client device 104 messages to client device 106.

A control device 110 is a device used to execute a control function. Non-limiting examples of a control device include actuators, dashboard, control panel, equipment, or machinery. In some embodiments, client device 108 is configured to control a control device 110 to accomplish an intended control function. In an example implementation, the client device (e.g., client device 108) includes a control engine 109. A control protocol defines how control engine 109 receives messages to, in turn, execute the control functions. Messages operating to control the control device 110 are referred to sometimes herein as control messages. Control messages are composed according to the control protocol to cause the control device 110 to operate according to the intended control function. A non-limiting example of a control protocol is the Open Platform Communication (OPC) protocol. However, other types of protocols may be used and still be within the scope of the embodiments described herein.

In an example embodiment, broker device 102 is configured to collect information relevant to control device 110 from messages it receives from other client devices. This is accomplished by processing the messages that broker device 102 receives from other client devices according to the respective format(s) of those messages. Broker device 102 is also configured to compose control messages structured in accordance with the control protocol and send the control messages to the corresponding client device (e.g., client device 108). After receiving the control messages structured in accordance with the control protocol, the client device (e.g., client device 108) controls the control device 110 according to the intended control function(s) carried by the control messages.

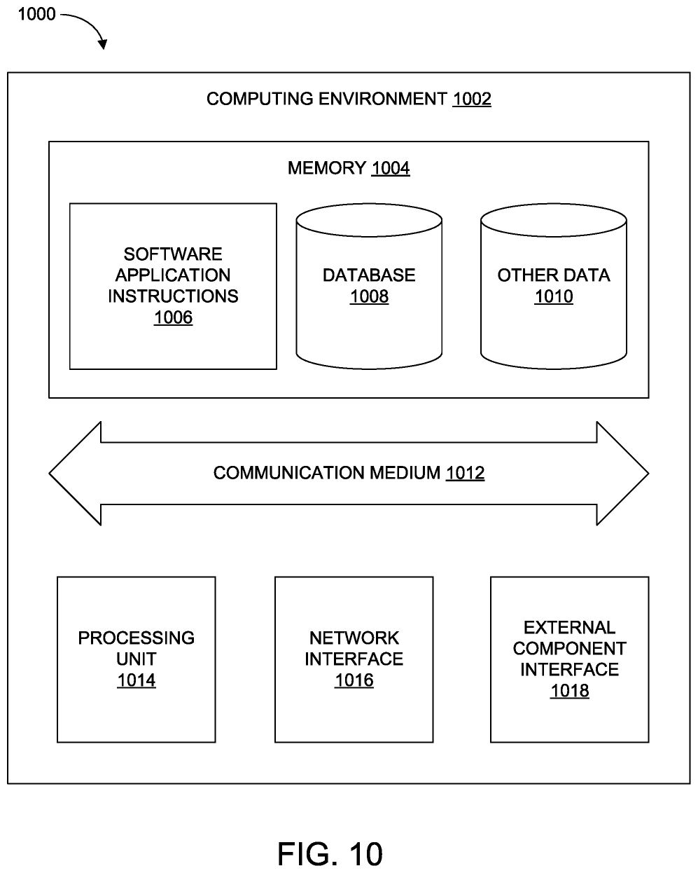

In some embodiments, broker device 102 is configured to receive messages from client devices and process the messages according to their respective formats, and further store the information contained in the messages. The information from the client device messages stored in broker device 102 can, in turn, be accessed and operated on by cloud computing environment 112, database 114, and computing system 116. Non-limiting examples of cloud computing environment 112 include Amazon Web Services' (AWS) cloud computing and web services, Microsoft® Azure or other computing, web services, or analytical tools, over a local area network (LAN) or as a cloud-based service. Examples of database 114 include a historical data storage facility, a relational database, a time series historian system or a cloud-based data storage service. Examples of the computing system 116 include a computing system that will be described below in more details in connection with FIG. 10. To transmit information from the broker device 102 to the cloud computing environment 112, the database 114, or the computing system 116, the broker device 102 is configured to compose messages structured according to their respective formats.

In some embodiments, heterogeneous system 100 is an IoT system. Heterogeneous system 100 can be configured to communicate under the MQTT protocol. As explained above, MQTT is an inter-process communication protocol designed to allow applications such as IoT applications to communicate with one another via a publish/subscribe communication model. An MQTT system can consist of a single “broker” application that acts as a server, and one or more “client” applications that send and receive messages to and from the broker. The broker's purpose is to act as a central point of contact for all clients in the system, and to route messages written by clients to other clients that have subscribed to them. Messages are distinguished by “topics”, which are unique names represented as strings. Clients write messages to a topic to publish data into the system, and other clients subscribe to those topics to express an interest in receiving those messages. Client applications do not communicate directly with one another, instead either publishing or subscribing to topics in the broker.

In an example embodiment, broker device 102 is configured to operate as a broker device operating a broker application. In some embodiments, the client devices (e.g., client device 104, client device 106, client device 108) are configured to operate as publisher devices executing publisher applications. In some embodiments, the client devices are configured to operate as subscriber devices executing subscriber applications. In some embodiments, the client devices are configured to operate as both publisher devices operating publisher applications and subscriber devices executing subscriber applications. Examples of message formats under which the client devices operate include JSON, XML, or CSV, among others.

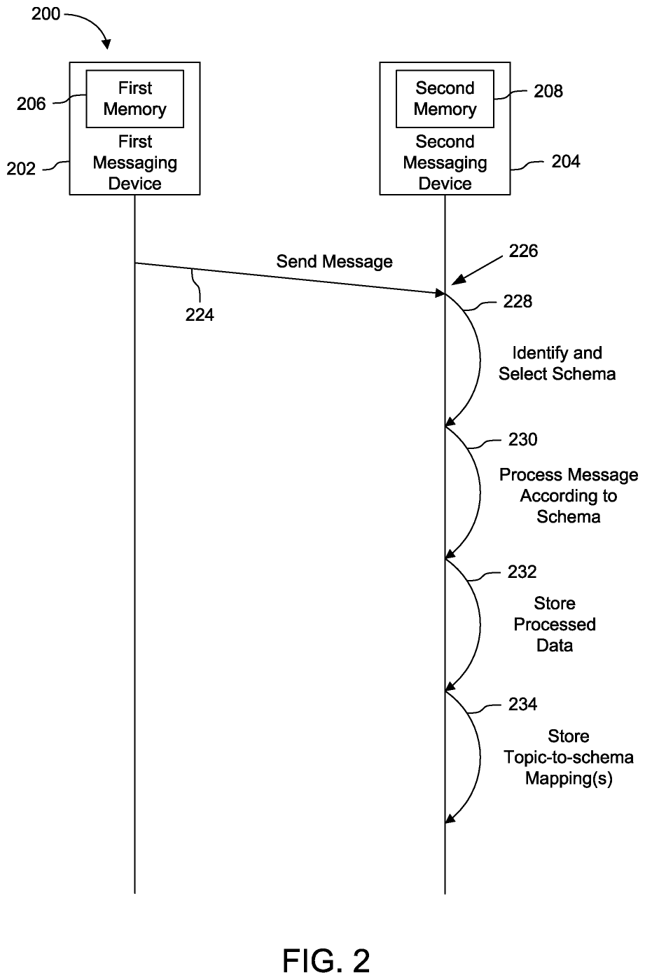

FIG. 2 is a system flow diagram illustrating an example system and processes 200 for sending and receiving messages in a heterogeneous environment between a first messaging device 202 and a second messaging device 204. The first messaging device 202 includes a first memory 206 configured to store a schema (referred to also sometimes as a known schema, an associated schema, a predetermined schema, a particular schema, a prestored schema, or the like). A schema as used herein is a data structure that includes fields of the transmission of user data and control data. The fields are predetermined by a particular protocol. The composition of a schema, especially the number and types of fields, may vary according to the particular protocol. In an example, each schema is associated with a specification for messages. A specification defines how a message should be translated into information that is understandable to the consumer of the message, for example, where the consumer of the message is a device. Particularly, the specification for messages consists of a schema that defines a syntax of a payload, and a handler that defines how to apply semantic meaning to the information in the payload. The schema is used to determine whether a specific payload is a well-formed example of the expected payload. The handler is used to extract, from a message structured according to a certain schema, information that is understandable to machines or humans regardless of the type of the schema.

In an example implementation, a payload is compared to a schema prestored in memory. In turn, a determination is made whether the payload is a valid implementation of that schema. The determination can be made, for instance, by determining if the payload is formatted according to a predetermined format. A format is generally defined as the syntax of a message while a schema is more specifically defined as the organization of specific information expressed in that format (for instance, according to a certain hierarchy of data type fields with their corresponding data value fields). Messages composed in the same format can nevertheless be of various schemas. Validation is performed by comparing the incoming payload against the schema to determine whether the payload matches the schema definition, using methods according to the schema definition. In an example implementation, a determination is made whether the payload is formatted according to the JSON format. If for example, the payload contains JSON text, then the schema could be expressed according to the IETF (Internet Engineering Task Force) draft JSON Schema specification. If the payload consists of XML text, for example, then the schema could be expressed as an XML schema or an XML document type definition (DTD). Other payload contents and schemas are also possible. If a payload content matches a particular schema, then the payload is determined to have been validated against that particular schema. No specific schema formalization is necessary so long as a mechanism exists to process and interpret a message format. For example, a device might produce a CSV document with three lines of the form “device, string”, “time, timestamp” and “value, float”. Although no formal schema may exist for this format, computer code built for the purpose could recognize and process messages in this format. Thus, in some examples, broker device 102 operates to interpret the format of a message. In cases where no formal schema exists, it may be possible to generate a schema from a sample payload. For example, it is possible to generate a proposed schema from a JSON payload using a JSON schema generator.

A handler can be any mechanism that can extract information from the payload and express the information in a form embodying the semantic knowledge the payload contains or implies. Extracted information expressed in a form embodying the semantic knowledge the payload contains or implies is referred to as the handler output. The handler is thus configured to extract information from the payload and apply semantic knowledge to that information to add semantic meaning. In an example implementation of a handler, one or more scripts process a payload to produce output in a human-readable or machine-readable form. For example, the handler could produce its output as OPC (Open Platform Communications) items in an OPC server, as records in a CSV (comma-separated values) file, as records in a database, the body of an email message, or any other form.

For example, a weather station that produces this JSON payload:

```
{
  “Measurement1”: 123.45,
  “Measurement2”: 31,
  “Measurement3”: 67.4
}
```

on the topic:
Toronto/NorthWest/Station7

can be processed by a handler to produce the output:
Toronto.NorthWest.Station7.Pressure=123.45
Toronto.NorthWest.Station7.Temperature=31
Toronto.NorthWest.Station7.Humidity=67.4

Depending on both the content of the payload and user input, the handler extracts information from the payload and applies knowledge to that information to add semantic meaning.

Referring still to FIG. 2, the second messaging device 204 includes a second memory 208, which is configured to store at least one schema including the schema stored in the first memory 206 and at least one processing rule (for example, the handler). In an example implementation, a processing rule is defined as a script. In a heterogenous system, payloads from different publishers contain messages expressed according to different schemas. An application that can process all the expected payloads distinguishes the correct specification (the schema and associated handler) for each incoming payload. This can be accomplished by pre-configuring the application to associate specific topics with specific specifications. More generally, an application can examine each incoming topic, attempt to validate the payload against each schema in turn, and associate zero or more specifications with that payload. If a payload validates against a schema, then the associated handler is applied to the payload to produce the associated handler output. In some examples, the second messaging device 204 is configured to store rules about additional logic in the second memory 208. Using the additional logic, the second messaging device 204 is configured to check whether tags in the received message include any error.

The first messaging device 202 and the second messaging device 204 are configured to be in communication with each other, including wireless, wired, or any other types of communication. As shown in transmission operation 224, the first messaging device 202 is configured to send a message structured according to a schema from the first messaging device 202 to the second messaging device 204 via the communication connection. The second messaging device 204 is configured to receive the message as shown in message receive operation 226 and identify that the message is structured according to the schema prestored in the second memory 208, as shown in schema identification operation 228. The schema is selected, and the message is to be processed according to the schema. The second messaging device 204 is configured to process the message after the identification and selection using a processing rule to generate processed data, as shown in data processing operation 230 and store the processed data in the second memory 208, as shown in data storage operation 232. In some examples, the second messaging device 204 is also configured to store zero or more topic-to-schema mappings in the second memory 208 to map the schema to a topic that the message is associated to, as shown in topic-to-schema storage operation 234. Each time the second messaging device 204 receives a message, second messaging device 204 is configured to check whether the topic associated with the received message exists in any of the topic-to-schema mapping stored in the second memory 208. If yes, the second messaging device 204 is configured to identify that the message is structured according to the schema that is mapped to the topic. Otherwise, the second messaging device 204 is configured to attempt to identify the message against all schemas that are stored in the second memory 208 until the second messaging device 204 successfully identifies that the message is structured according to one of the schemas stored in the second memory 208. In this case, the identified schema is selected and the second messaging device 204 is configured to update the topic-to-schema mappings stored in the second memory 208 accordingly.

In other embodiments, the first messaging device 202 and the second messaging device 204 can be a first application operating on a first computing device and a second application operating on a second computing device. In further embodiments, the first messaging device 202 and the second messaging device 204 can be two applications operating on a single computing device or a distributed computing environment. Examples of the computing devices, systems and environments include those described in FIG. 10. In yet further embodiments, the first messaging device 202 and the second messaging device 204 can be two different threads of a single application, such as software application instructions 1006 described in FIG. 10.

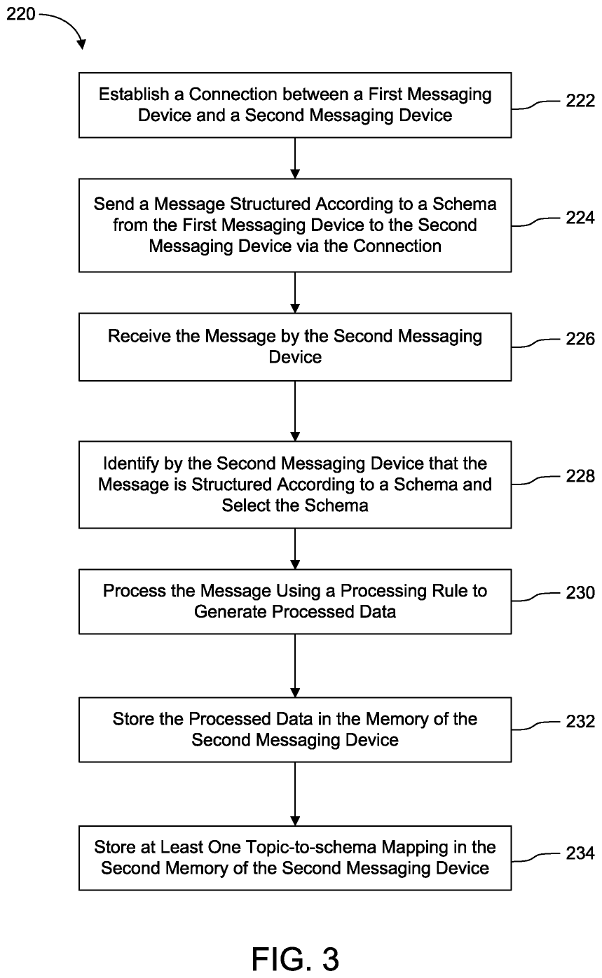

Referring to both FIG. 2 and FIG. 3, an example method 220 for sending and receiving messages in a heterogeneous environment. In some examples, the example method 220 is performed by the example system 200. In this illustrated example, the method 220 includes operations 222, 224, 226, 228, 230, 232, and 234. A connection operation 222 performs establishing a connection between a first messaging device and a second messaging device. A transmission operation 224 performs sending a message structured according to the schema prestored in the first memory 206 from the first messaging device to the second messaging device via the connection. Message receive operation 226 performs receiving the message by the second messaging device. Schema identification operation 228 performs identifying the second messaging device that the message is structured according to the schema prestored in the second memory 208. The schema is selected, and the message is to be processed according to the schema. Data processing operation 230 performs processing the message using a processing rule to generate processed data. Data storage operation 232 performs storing the processed data in the memory of the second messaging device. Topic-to-schema storage operation 234 performs storing one or more topic-to-schema mappings in the second memory 208 to map the schema to a topic associated with the message.

In other embodiments, example method 220 can be performed by a first application operating on a first computing device and a second application operating on a second computing device. In further embodiments, the example method 220 can be performed by two applications operating on a single computing device or a distributed computing environment. Examples of the computing devices, systems, and environments include those described in connection with FIG. 10. In yet further embodiments, the example method 220 can be performed by two different threads of a single application such as software application instructions 1006 in FIG. 10.

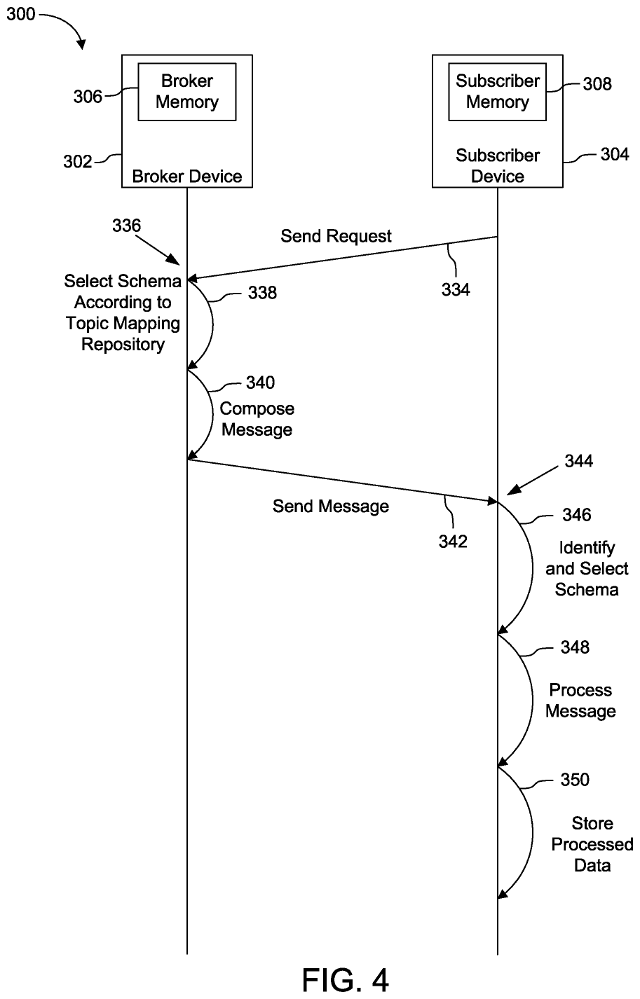

FIG. 4 is a system flow diagram illustrating an example system and processes 300 for sending and receiving messages in a heterogeneous environment between a broker device 302 and a subscriber device 304. The broker device 302 and the subscriber device 304 are configured to be in communication with each other via a connection. The broker device 302 includes a broker memory 306, which is configured to store a topic mapping repository and a plurality of schemas. The topic mapping repository includes at least one topic-to-schema mapping, which may include a “default” mapping that specifies a schema to apply to otherwise unmapped topics. Each schema is associated with a set of processing rules corresponding to that schema. In some examples, the first messaging device 202 described in connection with FIG. 2 is configured to be the broker device 302. The topic mapping repository stored in the broker memory 306 maps the plurality of schemas to a plurality of topics, each of the schemas corresponding to one or more topics. This can be accomplished, for instance, by pre-configuring the application or broker device 302 to associate specific topics with specific specifications, which include schemas and handlers.

The subscriber device 304 includes a subscriber memory 308 and is configured to send a subscription request, via the first connection, to the broker device 302 indicating a topic that it intends to subscribe from the broker device 302, as shown in subscription request operation 334. In some examples, the second messaging device 204 described in connection with FIG. 2 is configured to be the subscriber device 304. After receiving the subscription request as shown in request receive operation 336, the broker device 302 is configured to select a target schema corresponding to the topic, according to the topic mapping repository, as shown in schema selection operation 338. The appropriate schema is selected in preparation for relaying the information received from other messaging devices by routing another target message intended for the subscriber device 304. The broker device selects the target schema by looking up the topic in the topic mapping repository and selecting the schema associated with the topic. If no such mapping exists in the topic mapping repository then no message is composed for relaying the information. The broker device 302 is configured to compose a target message structured according to the target schema, as shown in message composition operation 340. In some examples, composing a message mixes literal text with computer code to form a text string that includes variable information. The broker device 302 is configured to send the target message structured according to the target schema to the subscriber device 304 via the communication connection, as show in message delivery operation 342. The subscriber device 304 is configured to identify that the target message is structured according to the target schema, as shown in message identification operation 346. The target schema is selected, and the message is to be processed according to the target schema. The subscriber device 304 is configured to process the message after identification and selection using a processing rule associated with the target schema to generate processed data as shown in message processing operation 348 and store the processed data in the subscriber memory 308, as shown in data storage operation 350. In some embodiments, the operations 344, 346, 348, and 350 are not performed.

In other embodiments, the broker device 302 and the subscriber device 304 can be a first application operating on a first computing device and a second application operating on a second computing device. In further embodiments, the broker device 302 and the subscriber device 304 can be two applications operating on a single computing device or a distributed computing environment. Examples of the computing devices, systems and environments include those that are described in connection with FIG. 10. In further embodiments, the broker device 302 and the subscriber device 304 can be two different threads of a single application, for example, in the case of software application instructions 1006 of FIG. 10.

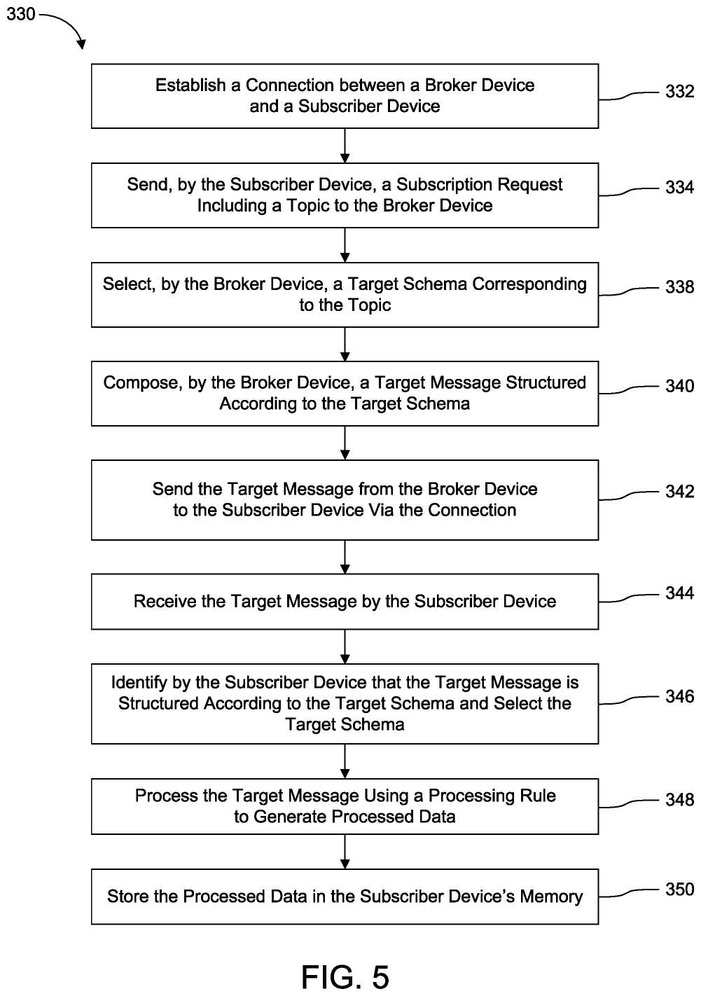

FIG. 5 illustrates an example method 330 for sending and receiving messages in a heterogeneous environment. Referring to both FIG. 4 and FIG. 5, in some examples, the example method 330 is performed. In this illustrated example, the method 330 includes operations 332, 334, 338, 340, 342, 344, 346, 348, and 350. Operation 332 is performed to establish a connection between a broker device and a subscriber device. Subscription request operation 334 is performs sending, by the subscriber device, a subscription request including a topic to the broker device. In some embodiments, the broker device receives the request message by performing a request receive operation 336 as described in connection with FIG. 4.

Schema selection operation 338 performs selecting, by the broker device, a target schema corresponding to the topic according to the topic mapping repository. Message composition operation 340 performs composing, by the broker device, a target message structured according to the target schema. Message delivery operation 342 performs sending the target message from the broker device to the subscriber device via the connection. Message receive operation 344 performs receiving the target message by the subscriber device. Message identification operation 346 performs identification by the subscriber device that the target message is structured according to the target schema. The target schema is selected, and the message is processed according to the target schema. Message processing operation 348 performs processing the target message using a processing rule associated with the target schema to generate processed data. Data storage operation 350 performs storing the processed data in the subscriber device's memory. In some examples, the operations 344, 346, 348, and 350 are not performed.

In other embodiments, the example method 330 can be performed by a first application operating on a first computing device and a second application operating on a second computing device. In further embodiments, the example method 330 can be performed by two applications operating on a single computing device or a distributed computing environment. Examples of the computing devices, systems and environments include those that will be described with more details in FIG. 10. In yet further embodiments, the example method 330 can be performed by two different threads of a single application as in the case of software application instructions 1006 of FIG. 10.

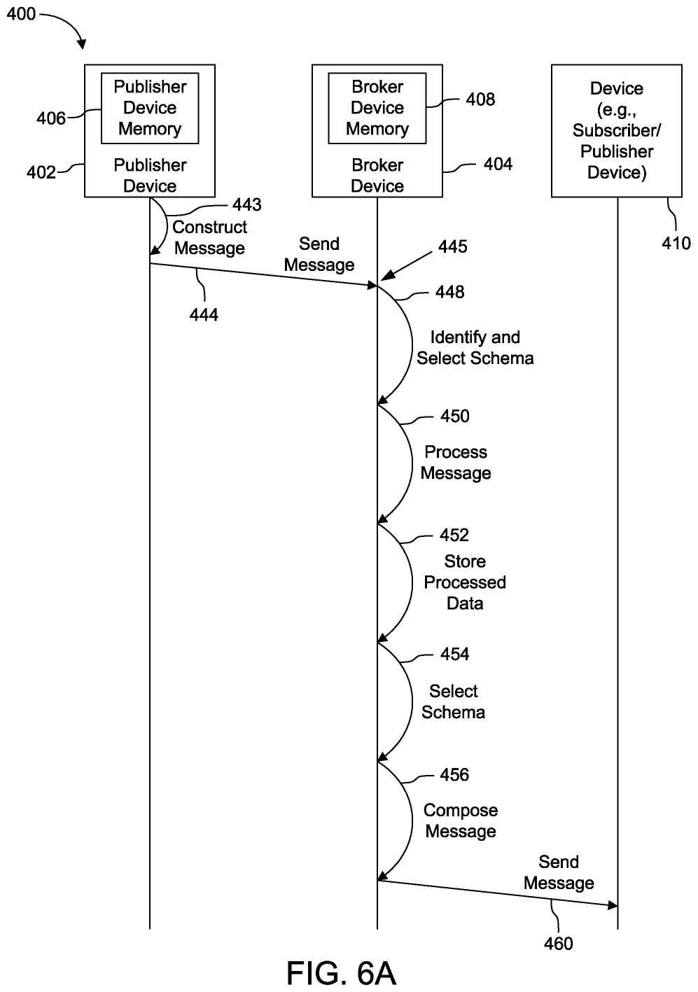

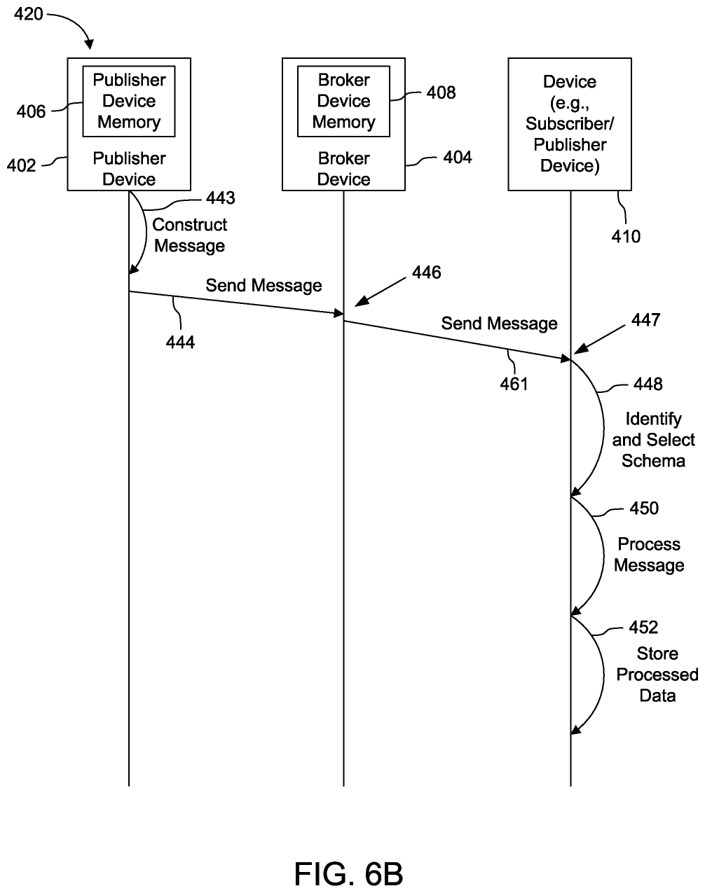

FIG. 6A is a system flow diagram illustrates an example system and processes 400 for sending and receiving messages in a heterogeneous environment between a publisher device 402 having a publisher memory 406, and a broker device 404 having a broker memory 408. The publisher device 402 and the broker device 404 are configured to be in communication with each other via a first connection. In some examples, the first messaging device 202 (illustrated and described in FIG. 2) is configured to be the publisher device 402. In this example embodiment, the publisher device 402 is configured to construct a published message including a published topic, structured according to a schema that is associated with the published topic, as shown in message construction operation 443. The publisher device 402 is configured to send the published message to the broker device 404 via the first communication connection, as shown in transmission operation 444. The broker device 404 is configured to receive the published message as shown at message receive operation 446.

The broker device 404 includes the broker memory 408, which is configured to store a topic mapping repository and a plurality of schemas including the schema associated with the published topic. In some examples, the second messaging device 204 (illustrated and described in FIG. 2) is configured to be the broker device 404. The broker device 404 is configured to identify that the published message is structured according to the associated schema after receiving the published message from the publisher device 402, as shown in schema identification operation 448. The associated schema is selected, and the message is processed according to the associated schema. The broker device 404 is configured to process the published message after identification and selection using an associated processing rule to generate processed data, as shown in data processing operation 450 and store the processed data in the broker memory 408, as shown in data storage operation 452.

In some embodiments, the broker device 404 is further configured to select a target schema corresponding to a target topic, according to the topic mapping repository, as shown at schema selection operation 454. The target topic is independent from the published topic and the target schema is independent from the associated schema. Thus, in some embodiments, the target topic is different than the published topic and the target schema is different than the associated schema. In other embodiments, the target topic is same as the published topic and the target schema is same as the associated schema. The selection is in preparation for relaying information extracted from processing the published message by routing another target message intended for a third device. For example, another subscriber device may have subscribed to a topic associated with the published message. With that information, the broker device 404 is configured to compose a target message structured according to the target schema from the processed data, which the subscribing third device will be able to parse, as shown at message composition operation 456.

In other embodiments, the example system 400 includes a third device 410 configured to be in communication with the broker device 404 via a second connection. The broker device 404 is configured to send the target message to the third device 410 via the second connection, as shown in transmission operation 460. The third device 410 may be, another subscriber device or another publisher device. For example, publisher device may publish a payload on a topic in a recognized schema that is handled by its associated handler, which then results in a data change event that is interpreted as a write request by a different specification, resulting in a new payload being written to a different topic destined for a different publisher. The effect is that two publishers with incompatible payload schemas can communicate with one another, preserving semantic meaning, using the present invention. In some embodiments, the third device 410 may be a cloud computing environment including Amazon AWS, Microsoft Azure or other analytical tools running on the same computer, over a LAN or as a cloud-based service. The third device 410 may also be a database including historical data storage facilities, relational database, time series historian system or a cloud-based data storage service. In yet further embodiments, the third device 410 can be a device configured to control a control system based on a control protocol (illustrated and described in FIG. 1).

FIG. 6B is a system flow diagram illustrating another example system and processes 420 for sending and receiving messages in a heterogeneous environment, which is a variant from the example system and processes 400. In this illustrated example, as shown at transmission operation 461, the broker device 404 is configured to send the message received from the publisher device 402 without processing the message (as illustrated and described in connection with FIG. 6A at operations 448, 450, 452, 454, and 456). Instead, the third device 410 is configured to receive a heterogenous message as shown at message receive operation 447 and perform operations 448, 450, and 452 (as illustrated and described in connection with FIG. 6A). The third device 410 is configured to interpret heterogenous messages, allowing interoperability. In some embodiments, the system 420 includes an MQTT broker, an OPC server and a built-in MQTT client that processes different schemas, wherein the MQTT broker is a standard broker that simply relays data.

Note that the systems 400 and 420 are not limited to the illustrated examples in FIG. 6A and FIG. 6B. In other embodiments, the publisher device 402, the broker device 404, and the third device 410 may be multiple applications operating on their corresponding multiple computing devices, respectively. In other embodiments, the publisher device 402, the broker device 404, and the third device 410 may be multiple applications operating on a single computing device or a distributed computing environment. Examples of the computing devices, systems and environments include those described in connection with FIG. 10. In other embodiments, the publisher device 402, the broker device 404, and the third device 410 can be multiple different threads of a single application (for example, one described as software application instructions 1006 in FIG. 10).

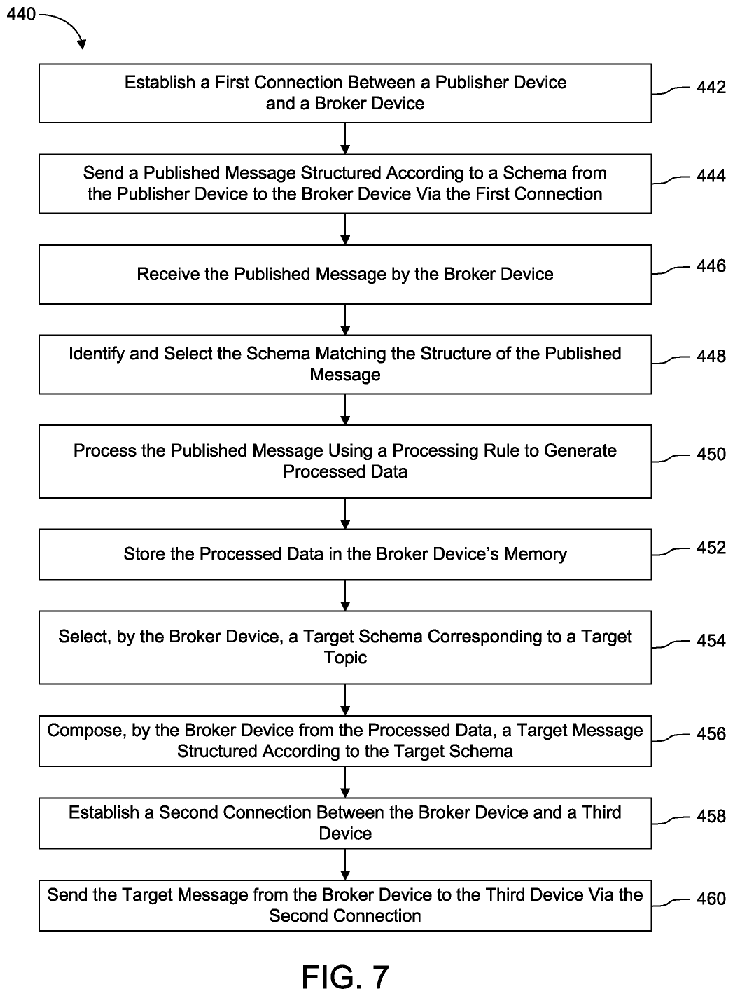

Referring to FIG. 7, it illustrates an example method 440 for sending and receiving messages across multiple devices in a heterogeneous environment. In some examples, the example method 440 is performed in the example system 400. In this illustrated example, the method 440 includes operations 442, 444, 446, 448, 450, 452, 454, 456, 458, and 460. The connection operation 442 is performed to establish a first connection between a publisher device and a broker device. Transmission operation 444 performs sending a published message structured according to an associated schema from the publisher device to the broker device via the first connection. Message receive operation 446 performs receiving the published message by the broker device. Schema Identification operation 448 performs identifying by the broker device that the published message is structured according to the associated schema. The associated schema is selected, and the message is to be processed according to the associated schema. Data processing operation 450 performs processing the published message using a processing rule to generate processed data. Data storage operation 452 performs storing the processed data in the broker device's memory. Schema selection operation 454 performs selecting, by the broker device, a target schema corresponding to a target topic. Message composition operation 456 performs composing, by the broker device from the processed data, a target message structured according to the target schema. Connection operation 458 performs establishing a second connection between the broker device and a third device. Transmission operation 460 performs sending the target message from the broker device to the third device via the second connection.

In some embodiments, the example method 440 may be performed by multiple applications operating on their corresponding multiple computing devices, respectively. In other embodiments, the example method 440 may be performed by multiple applications operating on a single computing device or a distributed computing environment. Examples of the computing devices, systems and environments include those that are described with more details in connection with FIG. 10. In other embodiments, the example method 440 can be performed by multiple different threads of a single application (for example, one described as software application instructions 1006 in FIG. 10).

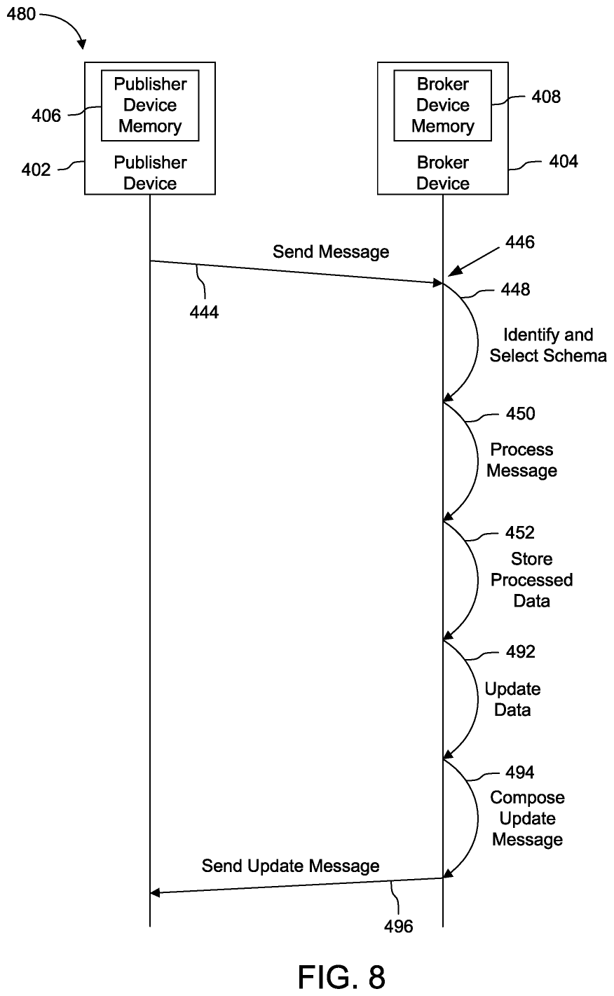

FIG. 8 depicts a system flow diagram 480 of another example system and processes for sending and receiving messages in a heterogeneous environment between the publisher device 402 having the publisher memory 406, and the broker device 404 having the broker memory 408. The publisher device 402 is configured to send a message structured according to a schema to broker device 404 via a communication connection, as shown in transmission operation 444. The broker device 404 is configured to identify that the message is structured according to the schema, as shown in schema identification operation 448.

The broker device 404 is further configured to process the published message using an associated processing rule to generate processed data as shown in data processing operation 450 and store the processed data in the broker memory 408 as shown in data storage operation 452. In the illustrated example in FIG. 8, the broker device 404 may be further configured to update the processed data, as shown in data generation operation 492, and compose an update message from the updated data, structured according to the original schema from the publisher device 402, as shown in message composition operation 494. In some examples, the update message may be associated with a different topic regardless of whether the schema changes. The broker device 404 is further configured to send the update message back to the publisher device 402 using the schema that the publisher device 402 adopts, as shown in transmission operation 496. That is, the example system 480 contains a mechanism by which it determines both a topic and a payload suitable for communication back to the original publisher of the incoming payload. This allows the current invention to write information back to the publisher, enabling closed-loop and supervisory control. The publishing format is specific to the original publisher, and is therefore associated with a previously identified specification concerning a topic on which an incoming payload was received. Once this association is made, any request to write data to the original publisher may be processed by the publishing format of the associated specification. For example, a change to an OPC item value may be treated as a request to write data to the publisher. This change could be expressed according to the publishing format and transmitted to the original publisher via a topic also produced by the publishing format. A request to write to the original publisher might originate from any source, for example, a change to an OPC value, an HTTP request, a change to a database, a user interaction, a scripted event, a timer, or any other source or event. More generally, a publishing format may specify multiple publishing payload formats, each associated with a different topic, all intended to write to the same original publisher.

Note that the system 480 is not limited to the illustrated example in FIG. 8. In other embodiments, the publisher device 402 and the broker device 404 may be multiple applications operating on their corresponding multiple computing devices, respectively. In other embodiments, the publisher device 402 and the broker device 404 may be multiple applications operating on a single computing device or a distributed computing environment. Examples of the computing devices, systems and environments include those that are described in more detail in connection with FIG. 10. In yet further embodiments, the publisher device 402 and the broker device 404 may be multiple different threads of a single application (for example, one described as software application instructions 1006 in FIG. 10).

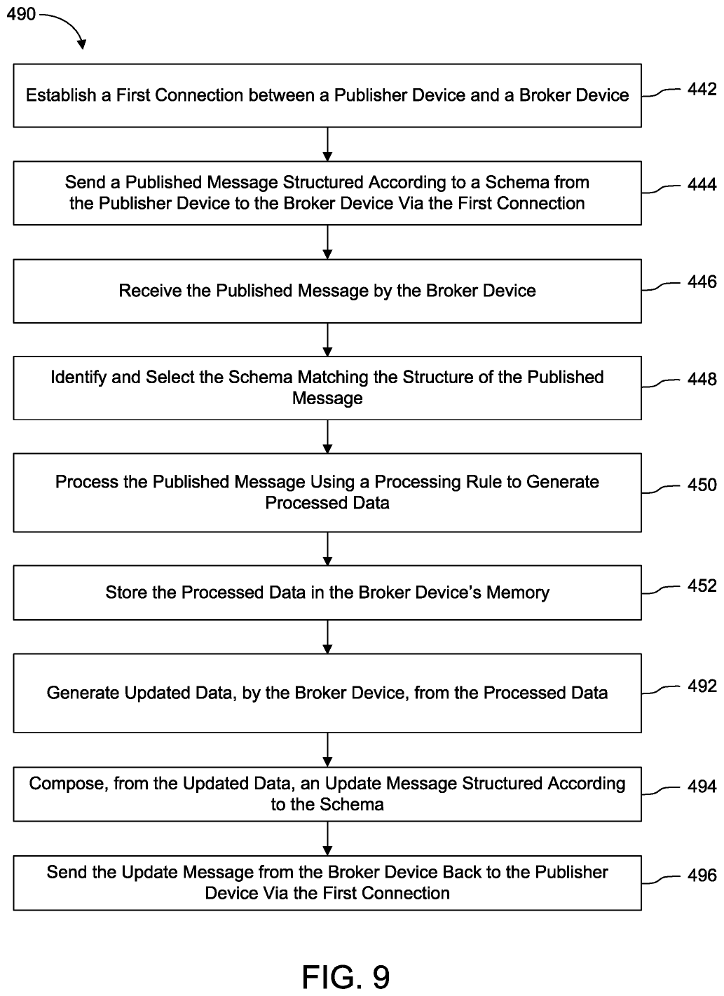

FIG. 9 illustrates another example method 490 for sending and receiving messages back and forth across multiple devices in a heterogeneous environment. In some embodiments, example method 490 is performed in the example system illustrated in the system flow diagram 480 of FIG. 8. In this illustrated example, the method 490 includes operations 442, 444, 446, 448, 450, and 452 of the example method 440 (illustrated and described in FIG. 7). In the illustrated example in FIG. 9, the method 490 further includes operations 492, 494, and 496. Data generation operation 492 performs generating updated data, by the broker device, from the processed data. Message composition operation 494 performs composing, from the updated data, an update message structured according to the schema. Transmission operation 496 performs sending the update message from the broker device back to the publisher device via the first connection.

In other embodiments, the example method 490 may be performed by multiple applications operating on their corresponding multiple computing devices, respectively. In further embodiments, the example method 490 may be performed by multiple applications operating on a single computing device or a distributed computing environment. Examples of the computing devices, systems and environments include those that are described in connection with FIG. 10. In other embodiments, the example method 490 can be performed by multiple different threads of a single application (for example, one described as software application instructions 1006 in FIG. 10).

FIG. 10 illustrates an example block diagram of a virtual or physical computing system 1000. One or more aspects of the computing system 1000 may be used to implement the heterogeneous messaging system and method described above in conjunction with FIGS. 1-9.

In some embodiments, the computing system 1000 may include a computing environment 1002. The computing environment 1002 can be a physical computing environment, a virtualized computing environment, or a combination thereof. The computing environment 1002 may include one or more of memory 1004, a communication medium 1012, one or more processing units 1014, a network interface 1016, and an external component interface 1018.

The memory 1004 may include a computer readable storage medium. The computer storage medium may be a device or article of manufacture that stores data and/or computer-executable instructions. The memory 1004 may include volatile and nonvolatile, transitory and non-transitory, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data known in the art.

The memory 1004 may store various types of data and software. For example, the memory 1004 may include software application instructions 1006, one or more databases 1008, as well as other data 1010.

In addition, the software application instructions 1006 may be included in non-transitory computer-readable medium having stored thereon one or more sequences of instructions, which when executed by one or more processors, cause the one or more processors to perform methods or implement systems described above in connection with FIGS. 1-9.

The communication medium 1012 may facilitate communication among the components of the computing environment 1002. In an example, the communication medium 1012 may facilitate communication among the memory 1004, the one or more processing units 1014, the network interface 1016, and the external component interface 1018. The communication medium 1012 may be implemented in a variety of ways including, but not limited to, a PCI bus, a PCI express bus accelerated graphics port (AGP) bus, a serial Advanced Technology Attachment (ATA) interconnect, a parallel ATA interconnect, a Fiber Channel interconnect, a USB bus, a Small Computing system interface (SCSI) interface, or another type of communications medium.

The one or more processing units 1014 may include physical or virtual units that selectively execute software instructions, such as the software application instructions 1006. In an example, the one or more processing units 1014 can be physical products comprising one or more integrated circuits. The one or more processing units 1014 may be implemented as one or more processing cores. In another embodiment, one or more processing units 1014 may be implemented as one or more separate microprocessors. In yet another embodiment, the one or more processing units 1014 may include an application-specific integrated circuit (ASIC) that provides specific functionality. In yet another embodiment, the one or more processing units 1014 provide specific functionality by using an ASIC and by executing computer-executable instructions.

The network interface 1016 enables the computing environment 1002 to send and receive data from a communication network. The network interface 1016 may be implemented as an Ethernet interface, a token-ring network interface, a fiber optic network interface, a wireless network interface (e.g., Wi-Fi), or another type of network interface.

The external component interface 1018 enables the computing environment 1002 to communicate with external devices. For example, the external component interface 1018 may be a USB interface, Thunderbolt interface, a Lightning interface, a serial port interface, a parallel port interface, a PS/2 interface, or another type of interface that enables the computing environment 1002 to communicate with external devices. In various embodiments, the external component interface 1018 enables the computing environment 1002 to communicate with various external components, such as external storage devices, input devices, speakers, modems, media player docks, other computing devices, scanners, digital cameras, and fingerprint readers.

The components of the computing environment 1002 may be spread across multiple computing environments 1002. For example, one or more of instructions or data stored on the memory 1004 may be stored partially or entirely in a separate computing environment 1002 that is accessed over a network.

Depending on the size and scale of the computing environment 1002, it may be advantageous to include one or more load balancers to balance traffic across multiple physical or virtual machine nodes. In one embodiment, the node balancer may be a node balancer product provided by F5 NETWORKS, INC. of Seattle, Wash.

Aspects of the computing system 1000 and the computing environment 1002 may be protected using a robust security model. In an example, users may be made to sign into the system using a directory service, such as ACTIVE DIRECTORY by MICROSOFT CORPORATION of Redmond, Wash. Connection and credential information may be externalized from jobs using an application programming interface. Credentials may be stored in an encrypted repository in a secured operational data store database space. Privileges may be assigned based on a collaboration team and mapped to a Lightweight Directory Access Protocol (LDAP) Group membership. A self-service security model may be used to allow owners to assign others permissions on their objects (e.g., actions).

Each node may be configured to be capable of running the entirety of the computing system 1000, such that portal can run and schedule jobs and serve the portal user interface as long as a single node remains functional. The environment 1002 may include monitoring technology to determine when a node is not functioning so an appropriate action can be taken.

In addition, it should be understood that the FIGS. 1-10 are presented for illustrative purposes only. The architecture of the example embodiments presented herein is sufficiently flexible and configurable that it may be utilized and navigated in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

The following are additional clauses relative to the present disclosure, which could be combined and/or otherwise integrated with any of the embodiments described above or listed in the claims below.

Clause 1. A method for messaging in a heterogeneous environment, comprising:

establishing a first connection between a first messaging device and a second messaging device, the first messaging device having a first memory configured to store a first schema and the second messaging device having a second memory configured to store at least one processing rule and at least one schema including the first schema;

sending, by the first messaging device to the second messaging device via the first connection, a first message, the first message being structured according to the first schema stored in the first memory;

receiving, by the second messaging device, the first message;

identifying, by the second messaging device, that the first message is structured according to the first schema stored in the second memory;

processing, by the second messaging device, the first message using the processing rule, wherein the processing generates processed data; and

storing the processed data in the second memory.

Clause 2. The method of Clause 1, further comprising:

configuring the first messaging device to be a broker device storing a topic mapping repository and a plurality of schemas in the first memory, wherein the topic mapping repository maps the plurality of schemas to correspond to a plurality of topics including a target topic;

selecting, from the plurality of schemas stored in the first memory, a target schema based on the target topic and the topic mapping repository, the target schema corresponding to the target topic; and

composing a target message structured according to the target schema,

wherein the first message sent by the first messaging device to the second messaging device via the first connection is the target message.

Clause 3. The method of any of Clauses 1 or 2, wherein the second messaging device is a subscriber device, the subscriber device being configured to send a subscription request, via the first connection, to the broker device indicating the target topic.
Clause 4. The method of any of Clauses 1-3, wherein the first messaging device is a publisher device, the publisher device being configured to construct a published message including a published topic, the published message being the first message sent by the first messaging device to the second messaging device via the first connection.
Clause 5. The method of any of Clauses 1-4, further comprising:

configuring the second messaging device to be a broker device storing a topic mapping repository and a plurality of schemas in the second memory, wherein the topic mapping repository maps the plurality of schemas to correspond to a plurality of topics including a target topic;

selecting, from the plurality of schemas stored in the second memory, a target schema based on the target topic and the topic mapping repository, the target schema corresponding to the target topic; and

composing, from the processed data, a target message structured according to the target schema.

Clause 6. The method of any of Clauses 1-5, further comprising:

establishing a second connection between the broker device and a third messaging devices, the third messaging device being configured to be a subscriber device; and

sending, by the broker device, the target message to the subscriber device.

Clause 7. The method of any of Clauses 1-6, further comprising:

storing, in the broker device, a control protocol defining at least one control rule for a control engine to control at least one actuator according to a control message;

composing, from the processed data, the control message structured according to the control protocol; and

sending, by the broker device, the control message to the subscriber device, wherein the subscriber device includes the control engine being configured to control the actuator according to the control message based on the control protocol.

Clause 8. The method of any of Clauses 1-7, further comprising:

establishing a second connection between the broker device and a data storage system, the data storage system being configured to store the processed data; and

sending, by the broker device, the target message to the data storage system.

Clause 9. The method of any of Clauses 1-8, further comprising:

establishing a second connection between the broker device and a data analysis system, the data analysis system being configured to analyze the processed data; and

sending, by the broker device, the target message to the data analysis system.

Clause 10. The method of any of Clauses 1-9, further comprising:

generating updated data, by the broker device, from the processed data;

composing, from the updated data, an update message structured according to the first schema, the update message being associated with the published topic; and

sending, by the broker device, the update message to the publisher device via the first connection.

Clause 11. The method of any of Clauses 1-10, wherein the first message is structured according to a Message Queue Telemetry Transport (MQTT) protocol.

Clauses 12. The method of any of Clauses 1-11, wherein the at least one processing rule is associated with the first schema.

Clause 13. A system for messaging in a heterogeneous environment, comprising:

at least one computing device;

at least one memory; and

a first application and a second application executable by the at least one computing device, wherein the first application is configured to send a first message to the second application, the first message be structured according to a first schema stored in the memory, and wherein the second application is configured to:
receive the first message from the first application,
identify that the first message is structured according to the first schema stored in the memory,
process the first message using a processing rule stored in the memory, wherein the processing generates processed data, and
store the processed data in the memory.
   Clause 14. The system of Clause 13, wherein the first application is executable by a first computing device of the at least one computing device and the second application is executable by a second computing device of the at least one computing device, the first computing device and the second computing device being configured to communicate via a first connection.
   Clause 15. The system of any of Clause 14, wherein the first computing device, executing the first application, is configured to:

receive a subscription request from the second computing device, the second computing device being configured to be a subscriber device;

store a topic mapping repository and a plurality of schemas in the first memory, wherein the topic mapping repository maps the plurality of schemas to correspond to a plurality of topics including a target topic;

select, from the plurality of schemas stored in the first memory, a target schema based on the target topic and the topic mapping repository, the target schema corresponding to the target topic; and

compose a target message structured according to the target schema,

wherein the first message sent by the first application to the second application is the target message.

Clause 16. The system of any of Clauses 14-15, wherein the first computing device, executing the first application, is configured to construct the first message to be a published message including a published topic, and wherein the second computing device, executing the second application, is configured to:

store a topic mapping repository and a plurality of schemas in the second memory, wherein the topic mapping repository maps the plurality of schemas to correspond to a plurality of topics including a target topic;

select, from the plurality of schemas stored in the second memory, a target schema based on the target topic and the topic mapping repository, the target schema corresponding to the target topic; and

compose, from the processed data, a target message structured according to the target schema.

Clause 17. The system of any of Clauses 13-16, further comprising a third application executable by a third computing device in communication with the second computing device via a second connection, wherein the second computing device, executing the second application, is further configured to send the target message to the third computing device via the second connection.
Clause 18. The system of any of Clauses 14-17, wherein the second computing device, executing the second application, is further configured to:

generate updated data from the processed data;

compose, from the updated data, an update message structured according to the first schema; and

send the update message to the first computing device via the first connection.

Clause 19. The system of any of Clauses 13-18, wherein the first application is executable as a first thread of a programming job and the second application is executable as a second thread of the programming job, the programming job being configured to be executed by the at least one computing device.
Clause 20. The system of any of Clauses 13-19, wherein the processing rule is associated with the first schema.
Clause 21. A non-transitory computer-readable medium having stored thereon one or more sequences of instructions, which when executed by one or more processors, cause the one or more processors to perform:

loading at least one processing rule and at least one schema from a memory;

receiving a first message;

identifying that the first message is structured according to the schema;

processing the first message using the processing rule, wherein the processing generates processed data; and

storing the processed data to the memory.

Clause 22. The non-transitory computer-readable medium of Clause 21, having stored thereon one or more sequences of instructions, which when executed by one or more processors, cause the one or more processors to further perform:

loading a topic mapping repository and a plurality of schemas from the memory, wherein the topic mapping repository maps the plurality of schemas to correspond to a plurality of topics;

loading a target topic from the memory, the target topic being associated with the processed data;

selecting, from the plurality of schemas, a target schema based on the target topic and the topic mapping repository, the target schema corresponding to the target topic; and

composing, from the processed data, a target message structured according to the target schema.

What is claimed is:

1. A method for messaging in a heterogeneous environment, comprising:
establishing a first connection between a first messaging device and a second messaging device, the first messaging device having a first memory configured to store a first schema and the second messaging device having a second memory configured to store at least one processing rule and at least one schema including the first schema;
sending, by the first messaging device to the second messaging device via the first connection, a first message, the first message being structured according to the first schema stored in the first memory;
receiving, by the second messaging device, the first message;
identifying, by the second messaging device, that the first message is structured according to the first schema stored in the second memory;
processing, by the second messaging device, the first message using the processing rule, wherein the processing generates processed data; and
storing the processed data in the second memory.

2. The method of claim 1, further comprising:
configuring the first messaging device to be a broker device storing a topic mapping repository and a plurality of schemas in the first memory, wherein the topic mapping repository maps the plurality of schemas to correspond to a plurality of topics including a target topic;
selecting, from the plurality of schemas stored in the first memory, a target schema based on the target topic and the topic mapping repository, the target schema corresponding to the target topic; and
composing a target message structured according to the target schema,
wherein the first message sent by the first messaging device to the second messaging device via the first connection is the target message.

3. The method of claim 2, wherein the second messaging device is a subscriber device, the subscriber device being configured to send a subscription request, via the first connection, to the broker device indicating the target topic.

4. The method of claim 1, wherein the first messaging device is a publisher device, the publisher device being configured to construct a published message including a published topic, the published message being the first message sent by the first messaging device to the second messaging device via the first connection.

5. The method of claim 4, further comprising:
configuring the second messaging device to be a broker device storing a topic mapping repository and a plurality of schemas in the second memory, wherein the topic mapping repository maps the plurality of schemas to correspond to a plurality of topics including a target topic;
selecting, from the plurality of schemas stored in the second memory, a target schema based on the target topic and the topic mapping repository, the target schema corresponding to the target topic; and
composing, from the processed data, a target message structured according to the target schema.

6. The method of claim 5, further comprising:
establishing a second connection between the broker device and a third messaging devices, the third messaging device being configured to be a subscriber device; and
sending, by the broker device, the target message to the subscriber device.

7. The method of claim 6, further comprising:
storing, in the broker device, a control protocol defining at least one control rule for a control engine to control at least one actuator according to a control message;
composing, from the processed data, the control message structured according to the control protocol; and
sending, by the broker device, the control message to the subscriber device, wherein the subscriber device includes the control engine being configured to control the actuator according to the control message based on the control protocol.

8. The method of claim 5, further comprising:
establishing a second connection between the broker device and a data storage system, the data storage system being configured to store the processed data; and
sending, by the broker device, the target message to the data storage system.

9. The method of claim 5, further comprising:
establishing a second connection between the broker device and a data analysis system, the data analysis system being configured to analyze the processed data; and
sending, by the broker device, the target message to the data analysis system.

10. The method of claim 5, further comprising:
generating updated data, by the broker device, from the processed data;
composing, from the updated data, an update message structured according to the first schema, the update message being associated with the published topic; and
sending, by the broker device, the update message to the publisher device via the first connection.

11. The method of claim 1, wherein the first message is structured according to a Message Queue Telemetry Transport (MQTT) protocol.

12. The method of claim 1, wherein the at least one processing rule is associated with the first schema.

13. A system for messaging in a heterogeneous environment, comprising:
at least one computing device;
at least one memory; and
a first application and a second application executable by the at least one computing device, wherein the first application is configured to send a first message to the second application, the first message be structured according to a first schema stored in the memory, and wherein the second application is configured to:
receive the first message from the first application,
identify that the first message is structured according to the first schema stored in the memory,
process the first message using a processing rule stored in the memory, wherein the processing generates processed data, and
store the processed data in the memory.

14. The system of claim 13, wherein the first application is executable by a first computing device of the at least one computing device and the second application is executable by a second computing device of the at least one computing device, the first computing device and the second computing device being configured to communicate via a first connection.

15. The system of claim 14, wherein the first computing device, executing the first application, is configured to:
receive a subscription request from the second computing device, the second computing device being configured to be a subscriber device;
store a topic mapping repository and a plurality of schemas in the first memory, wherein the topic mapping repository maps the plurality of schemas to correspond to a plurality of topics including a target topic;
select, from the plurality of schemas stored in the first memory, a target schema based on the target topic and the topic mapping repository, the target schema corresponding to the target topic; and
compose a target message structured according to the target schema,
wherein the first message sent by the first application to the second application is the target message.

16. The system of claim 14, wherein the first computing device, executing the first application, is configured to construct the first message to be a published message including a published topic, and wherein the second computing device, executing the second application, is configured to:
store a topic mapping repository and a plurality of schemas in the second memory, wherein the topic mapping repository maps the plurality of schemas to correspond to a plurality of topics including a target topic;
select, from the plurality of schemas stored in the second memory, a target schema based on the target topic and the topic mapping repository, the target schema corresponding to the target topic; and
compose, from the processed data, a target message structured according to the target schema.

17. The system of claim 16, further comprising a third application executable by a third computing device in communication with the second computing device via a second connection, wherein the second computing device, executing the second application, is further configured to send the target message to the third computing device via the second connection.

18. The system of claim 16, wherein the second computing device, executing the second application, is further configured to:
generate updated data from the processed data;
compose, from the updated data, an update message structured according to the first schema; and
send the update message to the first computing device via the first connection.

19. The system of claim 13, wherein the first application is executable as a first thread of a programming job and the second application is executable as a second thread of the programming job, the programming job being configured to be executed by the at least one computing device.

20. The system of claim 13, wherein the processing rule is associated with the first schema.

21. A non-transitory computer-readable medium having stored thereon one or more sequences of instructions, which when executed by one or more processors, cause the one or more processors to perform:
loading at least one processing rule and at least one schema from a memory;
receiving a first message;
identifying that the first message is structured according to the schema;
processing the first message using the processing rule, wherein the processing generates processed data; and
storing the processed data to the memory.

22. The non-transitory computer-readable medium of claim 21, having stored thereon one or more sequences of instructions, which when executed by one or more processors, cause the one or more processors to further perform:
loading a topic mapping repository and a plurality of schemas from the memory, wherein the topic mapping repository maps the plurality of schemas to correspond to a plurality of topics;
loading a target topic from the memory, the target topic being associated with the processed data;
selecting, from the plurality of schemas, a target schema based on the target topic and the topic mapping repository, the target schema corresponding to the target topic; and
composing, from the processed data, a target message structured according to the target schema.
